(19) United States
(12) Patent Application Publication
(10) Pub. No.: US 2016/0083638 A1
(43) Pub. Date: Mar. 24, 2016

(54) JUNCTION BOX AND POLYMER COMPOSITIONS FOR A JUNCTION BOX

(71) Applicant: DSM IP ASSETS B.V., TE Heerlen (NL)

(72) Inventors: Patrick Gerardus DUIS, Echt (NL); Adnan HASANOVIC, Echt (NL); Hans Klaas VAN DIJK, Echt (NL)

(21) Appl. No.: 14/785,494

(22) PCT Filed: Apr. 25, 2014
(86) PCT No.: PCT/EP2014/058490

§ 371 Date: Oct. 19, 2015

(30) Foreign Application Priority Data
Apr. 26, 2013 (EP) 13165468.3

(51) Int. Cl. C09K 5/08; C08L 77/02

(52) U.S. Cl. CPC C09K 5/08; C08L 77/02; C08L 2201/02; C08L 2205/025; C08L 2203/20

(57) ABSTRACT

The invention relates to a smart junction box made from a thermally conductive thermoplastic polymer composition comprising a thermoplastic polymer, between 10 and 40 wt. % of a thermally conductive (TC) filler, between 15 and 30 wt. % of a flame retardant (FR) and between 20 and 45 wt. % of glass fibres (GF). The invention also relates to a polymer composition comprising between 25 and 67.5 wt. % of at least one aliphatic polyamide, between 10 and 40 wt. % of a thermally conductive (TC) filler, between 15 and 30 wt. % of a flame retardant (FR) and between 7.5 and 40 wt. % of glass fibres (GF), wherein the weight percentages (wt. %) are relative to the total weight of the composition.

The invention relates to a smart junction box made from a flame retardant, glass fibre reinforced thermoplastic polymer composition. A smart junction box is understood to be a junction box, a housing for a micro inverter or for a power optimizer or functional combinations of these components.

In a photovoltaic (PV) power generation module, which transforms solar light energy into electricity, a junction box is provided for each module, in order to take out the electricity in a useful form. In the smart junction box, a by-pass diode or the like is arranged, which is a device for minimizing the influence of reduction in the output of the photovoltaic power generation module caused by a partial shadow cast on the surface of the module or a failure of a battery cell. In this case, since the by-pass diode generates heat, it is required that the whole junction box has a certain flame retardancy (FR) and thermal conductivity.

Junction boxes originally were made from alumina. Trials to make smaller junction boxes from alumina failed due to problems with creep currents, reason for which alumina was replaced by a thermoplastic. Smaller thermoplastic smart junction boxes however should have a good thermal conductivity to avoid overheating of the electronic components inside the box. In the smart junction box high temperatures are caused by heat sources like diodes, transistors, transformers, inductors, (MOS)FETS and/or IC's.

The junction box, which typically is installed in outdoors such as on a roof as an attachment of the photovoltaic power generation module, is required to have impact resistance to avoid damage during mounting of junction boxes on the roof and in particular, impact resistance at low temperatures is required. In order to improve the impact resistance and heat management of the smaller smart junction box, the wall thickness of the product has to be increased, or the box has to be enlarged contrary to the desired smaller dimension for junction boxes Similar to the junction box, impact resistance is required also for power converters and inverters, for which similar requirements are applied. For this reason, in this application, housings for micro inverters, power optimizers and functional combinations thereof are included in the definition of a smart junction box as well.

Other than installation on a roof the PV power generation module may be integrated in the building, thus forming a so-called Building Integrated Photo Voltaic power generation module (BIPV). For a BIPV the smart junction box should be invisibly integrated in the border of a bifacial power unit, which implies that the width should be 40 mm or less. This requires a high demand on thermal conductivity of the material to be used.

A junction box made from a thermally conductive thermoplastic polymer composition is known from WO2012/035976. WO2012/035976 describes junction boxes of different thermoplastic polymers comprising a long range of different filler materials whereby glass fibres and boron nitride to improve the rigidity, heat resistance and dimensional accuracy. WO12035976 is silent about specific amounts of fillers, thermal conductivity and low temperature impact behaviour of the junction box.

However for junction boxes high demands are raised with respect to thermal conductivity. US2012217434 describes encapsulation of electronics related to solar cells made from a polymer with a thermal conductivity of more than 1 W/mK by adding thermally conductive fillers like AIN, BN, SiC, graphite, expanded graphite, graphene, carbon fibres, or carbon nanotubes. US2012217434 however is silent about low temperature impact properties, which are required for junction boxes as well.

Although US2011232963 relates to a junction box with a −40° C. Charpy impact resistance by using a PPE/PS/HIPS compound, this application does neither describe any thermal conductivity, electrical conductance, flame retardant properties nor a low temperature impact according to UL 1703.

An object of the present invention is to provide a junction box of a thermally conductive thermoplastic polymer composition with a thermal conductivity of at least 1 W/mK, which is electrically isolating and which has a dart impact resistance according UL 1703 at a temperature of at least below −35° C., combined with a flame retardancy of 5VA@0,75mm according to UL 94.

According to the invention, this object is reached by the features of the junction box according to claim 1.

Another object of the invention is to provide a composition with good mechanical properties and good flame retardancy.

According to the invention, this object is reached by the features of the composition according to claim 5.

The composition comprises a combination of flame retardant, glass fibres and a thermally conductive filler. The composition comprising this combination of constituents shows a synergistic effect on tensile modulus, impact properties and flame retardancy.

The junction box of the present invention is made from a thermoplastic composition comprising a thermoplastic polymer, between 10 and 40 wt. % of a thermo conductive (TC) filler, between 15 and 30 wt. % of a flame retardant (FR) and between 7.5 and 40 wt. % of glass fibres (GF), wherein the weight percentages (wt. %) are relative to the total weight of the composition.

The total combined amount of TC filler, FR additive and glass fibres is suitable in the range of 32.5-70 wt. %, relative to the to the total weight of the composition. Preferably the combined amount is in the range of 40-65 wt. %, relative to the to the total weight of the composition.

The composition has also much better flow properties than corresponding compositions with a similar high tensile modulus comprising a higher glass fibres content but less or even no thermally conductive additive.

The thermally conductive fillers of the present invention are typically selected from a group of electrically isolating components, comprising, aluminum oxide, boron nitride, silicon carbide, aluminum nitride, titanium dioxide, magnesium hydroxide, magnesium oxide mica and combinations thereof. The composition should comprise at least 10 wt. % of a TC filler to provide a junction box with a thermal conductivity of at least 1 W/mK. Above 40 wt. % of the TC material, flow and mechanical properties decline, reason for which a complicated mould cannot be filled and the dart impact resistance according UL 1703 cannot be accomplished.

The thermoplastic composition of the present invention comprises from 20 to 30 wt. % of a flame retardant system. The flame retardant system may comprise a halogenated flame retardant and/or a halogen free flame retardant, and next to the said flame retardant or combination of flame retardants optionally also a flame retardant synergist. The halogenated flame retardant may be a brominated polymer, for example a brominated polystyrene (e.g. Saytex 7010 or Saytex 3010 of Albemarle Corp.), a polybromostyrene copolymer, a brominated epoxy resin and/or a brominated polyphenylene oxide. Suitably, the halogenated flame retardant is a brominated polystyrene with a high bromine content, for example in the range of 61-70 wt. %. The higher bromine content allows lower loadings of flame retardant, and for better flow properties. The halogen free flame retardant may suitably be a nitrogen containing flame retardant, a phosphorous containing flame retardant and/or a nitrogen and phosphorous containing flame retardant. Suitable halogen free flame retardants are for example phosphates, in particular polyphosphates, such as melamine polyphosphates, and phosphinates, in particular metal salts of organic phosphinates, such as calcium—and aluminium diethylphosphinate. Examples of suitable synergists are antimony compounds like antimony trioxide, antimony pentoxide, and sodium antimonite, and other metal oxide, and zinc borate and other metal borates. Preferably, the synergist is zinc borate.

The flame retardant system is present in a total amount of 20 to 30 wt. %, relative to the total weight of the composition.

The composition should comprise at least 15 wt. % of a flame retardant to provide a junction box with a flame retardancy of 5 VA according to UL 94. The composition should not comprise more than 30 wt. % of the flame retardant to avoid deterioration of mechanical properties of the junction box.

The thermoplastic compositions of the present invention comprises from 7.5 to 40 wt. % of glass fibres. The glass fibres may be surface treated with silanes to improve adhesion and dispersion with the polymeric matrix resin. With less than 7.5 wt. % of glass fibres the UL 1703 requirement cannot be obtained. Above 40 wt. % of glass fibres flow properties decrease. An additional advantage of the smart junction box according to the invention is, that it also passed the impact test according to EN 60068-2-75 (4 impacts with a 1 Joule hammer at −40° C.) for European TUV approval for solar cells.

In addition to the thermoplastic resin, the flame retardant, the glass fibres, and the TC filler, the thermoplastic compositions of the present invention may include various additives ordinarily incorporated in resin compositions of this type. Mixtures of additives may be used. Such additives may be mixed at a suitable time during the mixing of the components for forming the composition. The one or more additives are included in the thermoplastic compositions to impart one or more selected characteristics to the thermoplastic compositions and any moulded article made therefrom. Examples of additives that may be included in the present invention include, but are not limited to, heat stabilizers, process stabilizers, antioxidants, light stabilizers, plasticizers, antistatic agents, mould releasing agents, UV absorbers, lubricants, pigments, dyes, colorants, flow promoters, impact modifiers or a combination of one or more of the foregoing additives.

In a preferred embodiment of the invention the thermoplastic polymer composition comprises a polyamide. With a polyamide improved impact resistance at room temperature is obtained.

In an even more preferred embodiment of the invention, the polyamide is an aliphatic polyamide. Preferably the aliphatic polyamide is chosen from the group of PA46, PA6, PA66, PA66,6, PA 410 or mixtures thereof.

The invention further relates to a new polymer composition with a surprising combination of being electrically isolating, thermally conductive, and flame retardant and having a cold dart impact resistance at −40° C. This polymer composition comprises between 25 and 67.5 wt. % of at least one aliphatic polyamide, between 10 and 40 wt. % of a TC filler, between 15 and 30 wt. % of a FR and between 7.5 and 40 wt. % GF. Preferably the aliphatic polyamide is chosen from the group of PA46, PA6, PA66, PA66,6, PA 410, or mixtures thereof.

The thermoplastic compositions of the present invention may be formed using any known method of combining multiple components to form a thermoplastic resin. In one embodiment, the components are first blended in a high-speed mixer. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestream. The extruder is generally operated at a temperature higher than the melting temperature of the base polymer of the composition at hand. The extrudate is immediately quenched in a water bath and pelletized. The pellets so prepared when cutting the extrudate may be one-fourth inch long or less as desired. Such pellets may be used for subsequent moulding, shaping, or forming.

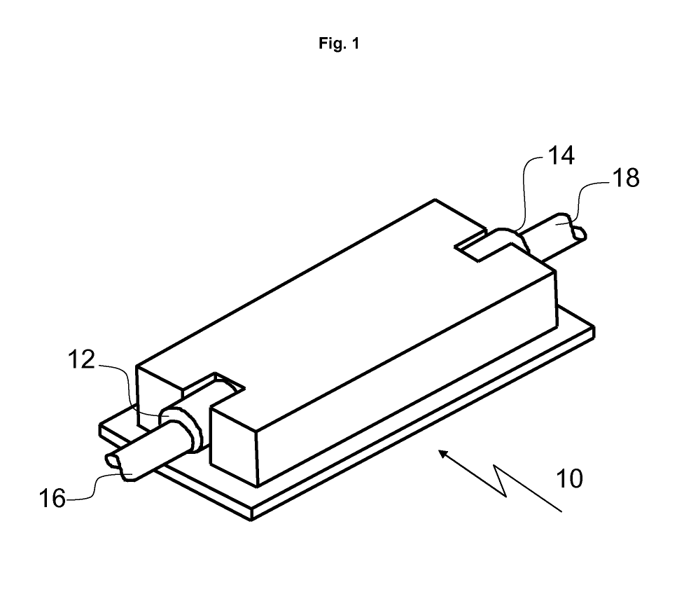

FIG. 1 shows a junction box 10 with two opposite openings 12 and 14 so that the two output cables 16 and 18 are able to respectively connect to the two opposite sides to output the electricity generated by the adjacent PV module (not shown).

### EXAMPLES

Table 1 comprises compositions according to the invention as well as comparative examples showing junction boxes according to FIG. 1 of different polymer compositions and there their corresponding thermal conductivity, flame retardant properties and cold dart impact resistance according to UL1703. It is surprisingly seen that a junction box comprising a TC filler and flame retardant additives failed in the cold dart impact test (CE-D), where a junction box wherein at least 10 wt. % of the TC filler is replaced by glass fibres passed this test. Also 15 wt. % of glass fibres without TC filler failed, so that the combination of glass fibres and TC fillers and flame retardant is required to obtain a junction box which fulfils the requirements of thermal conductivity low temperature impact and FR requirements.

As can be seen from the results in the Table 1, the compositions according to the inventions (Examples I-III), show a synergistic effect on tensile modulus, impact properties and flame retardancy. The Examples I-III show a much higher modulus than any of the other compositions in the Comparative Experiments A-E, comprising a similar level of combined filler load. The Examples I-III are also the only ones that pass the cold impact test, and also passed the stringent flame retardancy test conditions of UL 94 5VA.

TABLE 1

| | | Test | | | | | | | | |
|---|---|---|---|---|---|---|---|---|---|---|
| | Units | Standard | CE-A | CE-B | CE-C | CE-D | CE-E | EX-1 | EX-2 | EX-3 |
| PA 4,6 | wt. % | | 100 | 50 | 85 | 50 | 10 | 10 | 10 | 10 |
| PA6 | wt. % | | | | | | 30 | 30 | 30 | 30 |
| Flame Retardant System | wt. % | | | 40*** | | 35**** | 20** | 20** | 20** | 20** |
| Impact modifier | wt. % | | | 10 | | | | | | |
| GF | wt. % | | | | 15 | 15 | | 20 | 15 | 10 |
| BN | wt. % | | | | | | 40 | 20 | 25 | 30 |
| Tensile modulus | MPa | ISO 527/1A | 3300 | 3000 | 6100 | 8000 | 11000 | 14400 | 14000 | 13500 |
| Tensile stress strength | MPa | ISO 527/1A | 100 | 58 | 140 | 140 | 55 | 119 | 100 | 82 |
| Tensile elongation | % | ISO 527/1A | 45 | 17.5 | 4 | 3 | 0.6 | 1.8 | 1.7 | 1.4 |
| Cold impact test 51 mm | pass/fail | UL | passed | failed | failed | failed | failed | passed | passed | passed |
| dart @ −35° C., 6.78 J | | 1703 | | | | | | | | |
| FR class (*) | | UL94 V/UL94 | failed | V0 pass | failed | V0 pass | 5VA | 5VA | 5VA | 5VA |
| | | 5VA | | 5VA failed | | 5VA failed | passed | passed | passed | passed |
| Thermal conductivity in | W/mK | ASTM E1461 | 0.25 | 0.25 | 0.28 | 0.27 | 5 | 2.1 | 3.2 | 4.2 |
| plane | | | | | | | | | | |

(*) UL 94V and UL94 5VA @ 0.75 mm; After 48 hours, 23° C., 50% RH and 168 hours 70° C.
**15% Saytex HP3010 and 5% of a masterbatch with 80 wt. % Sb2O3 in PA6
***30% Saytex HP7010 en 10% of a masterbatch with 80 wt. % Sb2O3 in PA6 (CE-B)
****25% Saytex HP7010 en 10% of a masterbatch with 80 wt. % Sb2O3 in PA6 (CE-D)

1. Smart junction box made from a thermally conductive thermoplastic polymer composition comprising a thermoplastic polymer, between 10 and 40 wt. % of a thermally conductive (TC) filler, between 15 and 30 wt. % of a flame retardant (FR) and between 7.5 and 40 wt. % of glass fibres (GF), wherein the weight percentages (wt. %) are relative to the total weight of the composition.

2. Junction box according to claim 1, wherein the thermoplastic polymer composition comprises of a polyamide.

3. Junction box according to claim 2, wherein the polyamide is an aliphatic polyamide.

4. Junction box according to claim 1, wherein the thermally conductive filler is boron nitride.

5. Polymer composition comprising between 25 and 67.5 wt. % of at least one aliphatic polyamide, between 10 and 40 wt. % of a thermally conductive (TC) filler, between 15 and 30 wt. % of a flame retardant (FR) and between 7.5 and 40 wt. % of glass fibres (GF), wherein the weight percentages (wt. %) are relative to the total weight of the composition.

6. Polymer composition according to claim 5, wherein the aliphatic polyamide is chosen from PA46, PA6, PA66, PA66,6, PA410 or mixtures thereof.
